(19) United States
(12) Patent Application Publication
(10) Pub. No.: US 2015/0070929 A1
(43) Pub. Date: Mar. 12, 2015

(54) LIGHTING DEVICE HAVING A REFLECTOR, LENS, AND APERTURE

(71) Applicant: OSRAM GmbH, Muenchen (DE)

(72) Inventors: Daniel Weissenberger, Giengen (DE); Roland Fiederling, Friedberg (DE)

(21) Appl. No.: 14/391,710

(22) PCT Filed: Apr. 17, 2013
(86) PCT No.: PCT/EP2013/057983

§ 371 Date: Oct. 10, 2014

(30) Foreign Application Priority Data
Apr. 18, 2012 (DE) 10 2012 206 394.3

(51) Int. Cl. F21V 13/04; F21V 8/00; F21V 5/04; F21V 7/08; F21S 8/10

(52) U.S. Cl. CPC F21V 13/04; F21V 7/08; F21S 48/1317; F21V 5/045; F21S 48/1225; G02B 6/0031
USPC 362/606; 362/235; 362/516; 362/473

(57) ABSTRACT

A lighting device may include a reflector, which can be illuminated by means of at least one light source, in particular light emitting diode, a lens disposed downstream of the reflector, and an aperture interposed between the reflector and the lens. The aperture is designed and arranged to block one part of a light reflected by the reflector onto the aperture and to direct another part of the light reflected by the reflector onto the aperture onto the lens.

### RELATED APPLICATIONS

The present application is a national stage entry according to 35 U.S.C. §371 of PCT application No.: PCT/EP2013/057983 filed on Apr. 17, 2013, which claims priority from German application No.: 10 2012 206 394.3 filed on Apr. 18, 2012, and is incorporated herein by reference in its entirety.

### TECHNICAL FIELD

Various embodiments generally relate to a lighting device, including a reflector, which may be illuminated by means of at least one light source, in particular light emitting diode, a lens disposed downstream of the reflector, and an aperture interposed between the reflector and the lens. The present disclosure may be used particularly advantageously for vehicle lighting devices, in particular headlights.

### BACKGROUND

In the case of headlights for automobiles and trucks, in order to generate a low beam, an aperture is introduced into a beam path between a reflector and a lens of the headlight. The aperture blocks a portion of the light rays passing from the reflector to the lens, with the result that a sharp bright-dark boundary arises in the light emission pattern generated downstream of the lens in the far field. However, it may be desired, e.g. in order to increase a visibility of the headlight, to illuminate the basically dark region diffusely. For this purpose, it is known to modify a light entrance or light exit surface of the lens by means of light deflection structures such that it at least slightly projects light into the basically dark region as well. Light deflection structures may include e.g. depressions or rings. However, a brightness of the region that is primarily to be illuminated is reduced as a result. Moreover, a shaping and adaptation of the lens are comparatively complex.

### SUMMARY

Various embodiments provide a lighting device which, particularly simply and/or flexibly in terms of lighting technology, may provide scattered light in a spatial region shaded by an aperture.

Various embodiments provide a lighting device, including a reflector, which may be illuminated by means of at least one light source, a lens disposed downstream of the reflector, and an aperture interposed between the reflector and the lens, wherein the aperture is designed and arranged to block one part of a light reflected by the reflector onto the aperture and to direct another part of the light reflected by the reflector onto the aperture onto the lens.

By virtue of that part of the light which is directed onto the lens by the aperture, this light may be radiated in particular also into spatial regions which would otherwise be blocked or shaded by the aperture. Provision of an, in particular comparatively weak, light in addition to the light radiated onto the lens directly by the reflector is thus achieved in a simple manner. A design modification of the front or rear side of the lens with light deflection structures may be dispensed with.

In one development, the light reflected by the reflector onto the aperture is generated by a diffusely reflective region of the inner surface of the reflector. This light generated in this way has, in particular, a brightness which is significantly lower than the directed (useful) light reflected directly onto the lens by the reflector.

The light source may emit in particular UV light, visible light and/or IR light. The light source may be in particular a semiconductor light source. Preferably, the at least one semiconductor light source includes at least one light emitting diode. In the case where a plurality of light emitting diodes are present, they may emit light in the same color or in different colors. A color may be monochromatic (e.g. red, green, blue, etc.), or multichromatic (e.g. white). Moreover, the light emitted by the at least one light emitting diode may be an infrared light (IR LED), or an ultraviolet light (UV LED). A plurality of light emitting diodes may generate a mixed light; e.g. a white mixed light. The at least one light emitting diode may contain at least one wavelength-converting phosphor (conversion LED). The phosphor may alternatively or additionally be arranged in a manner remote from the light emitting diode (“remote phosphor”). The at least one light emitting diode may be present in the form of at least one individually packaged light emitting diode or in the form of at least one LED chip. A plurality of LED chips may be mounted on a common substrate (“submount”). The at least one light emitting diode may be equipped with at least one dedicated and/or common optical unit for beam guiding, e.g. at least one Fresnel lens, collimator, and so on. Instead of or in addition to inorganic light emitting diodes, e.g. based on InGaN or AlInGaP, generally organic LEDs (OLEDs, e.g. polymer OLEDs or small-molecules OLEDs) may also be used. Alternatively, the at least one semiconductor light source may include e.g. at least one diode laser.

In one configuration, moreover, the at least one light source for illuminating the reflector is dimmable. In this regard, light emission patterns or light functions with weaker light intensity, e.g. a daytime running light, may also be provided in a targeted manner.

In one configuration, the aperture is a partly transmissive aperture, that is to say that one part of the light radiated onto the rear side of the aperture by the reflector is transmitted and another part is blocked (e.g. absorbed and/or reflected without use). The transmitted light may then generate the additional, in particular small, light proportion, in particular scattered light proportion, in the light emission pattern.

The main body of the aperture may be embodied for example as translucent or milky (in particular for generating a scattered light without significant brightness peaks) and/or have a light-scattering surface structure at its light exit side (the front side).

In one configuration thereof, the aperture has a partly transmissive coating. Such a configuration may be provided particularly simply. The partly transmissive coating may be applied e.g. on a transparent or translucent main body.

In one particularly simple configuration, the aperture has at least one light transmitting opening and is otherwise light-non transmissive. The light impinging on the aperture (in particular the rear side thereof) from the reflector may therefore pass through the aperture in the region of the at least one light transmitting opening and emerge again (in particular at the front side) and then be radiated e.g. onto the lens.

In one configuration which is advantageous for shaping the desired additional proportion of the light emission pattern, in particular scattered light proportion, the aperture has a beam-shaping main body, e.g. in the form of a lens, in particular freeform lens.

However, the form of the aperture is arbitrary, in principle. By way of example, the aperture may also be of plate-shaped design, wherein the front side and the rear side of the aperture correspond to the two main sides of the plate. Such an aperture may be arranged in particular on or in a light exit plane of the reflector or outside the reflector.

The aperture may e.g. also be shaped such that its rear side is oriented in an angled fashion with respect to the front side, e.g. is perpendicular thereto. By way of example, the rear side may lie in the reflector, e.g. horizontally, and form for example at least part of the inner side of the reflector. The rear side may form for example a base or base region lying in a principal plane of the reflector.

In one configuration, moreover, the aperture is designed and arranged such that light incident on its rear side from the reflector may be at least partly blocked and its front side is embodied in a reflective fashion at least in regions. The aperture may be light-non transmissive or else partly transmissive, for example. This configuration has the advantage that the aperture may be produced particularly simply.

An associated at least one reflection surface on the front side may be embodied as specularly reflective or diffusely reflective. It is also preferred for the at least one reflection surface on the front side to be embodied as Gaussian-reflective or as a Gaussian mirror, the reflectance of which is location-dependent, in particular decreases or falls in a Gaussian manner from a center.

The shape of the at least one reflection surface on the front side is arbitrary, in principle, and may be e.g. concave mirror shaped (ellipsoid, paraboloid, freeform shaped, etc.) in order that a spatial delimitation of the additional light emitted thereby may be shaped in a targeted manner. However, the shape of the at least one reflection surface on the front side is not restricted thereto and may also be differently freeform shaped, for example.

In one configuration, furthermore, the aperture has at the top side and at its front side an optical waveguide that may be irradiated by the reflector and the optical waveguide is designed to couple out light at the front side. Consequently, light radiated onto the aperture at the rear side is blocked and light radiated onto the optical waveguide at the top side is forwarded to the front side (which is not irradiated by the reflector) and coupled out there. The coupling out takes place e.g. at imperfections, reflective or roughened regions and/or by means of coupling-out structures situated in the material and/or introduced at the surface. Alternatively or additionally, a dedicated or additional light source may be used for feeding the optical waveguide.

In one configuration, in addition, the front side of the aperture is covered with at least one phosphor, in particular with at least one phosphor layer. As a result, it is possible to generate a diffusely scattering mixed light as scattered light, etc. in a particularly simple manner. The mixed light is composed of, in particular, the primary light originally generated by the at least one additional light source and the wavelength-converted secondary light generated from the primary light by the at least one phosphor. Depending on the density, thickness, etc. of the phosphor, the degree of conversion of primary light to secondary light may be set and, if appropriate, it is also possible for only secondary light to be radiated onto the lens.

In yet another configuration, the reflector includes a half-shell reflector or is designed as such. This results in a particularly inexpensive and compact configuration, in particular since often only half of the emission pattern of a full-shell reflector is required and the light emission pattern advantageously has a maximum width at the bright-dark boundary. However, the reflector is not restricted thereto and may include, in particular, any suitable type of hollow reflector, e.g. also a full-shell reflector.

In one configuration, furthermore, the aperture has a cut-off edge (i.e. an edge for generating the bright-dark boundary) on a principal plane of the reflector. This produces a sharp bright-dark boundary at the widest point of the light emission pattern.

The lighting device may generally include one or a plurality of optical elements disposed downstream of the shell reflector, e.g. one or a plurality of lenses, further reflectors, light-transmissive covers, etc.

In one configuration, moreover, the lighting device is a vehicle lighting device, in particular headlight. In this case, in particular, the bright-dark boundary and the scattered light generation may be used advantageously, in particular at least for generating a low beam.

The type of vehicle is not restricted and may encompass for example waterborne vehicles (ships, etc.), airborne vehicles (airplanes, helicopters, etc.) and landborne vehicles (e.g. automobiles, trucks, motorcycles, etc.).

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a vehicle lighting device as a sectional illustration in side view;

FIG. 2 shows the vehicle lighting device as a sectional illustration in plan view;

FIG. 3 shows a frontal view of a light emission pattern generated behind the vehicle lighting device; and

FIGS. 4-13 show various embodiments of an aperture, for example of the vehicle lighting device in accordance with FIGS. 1 to 3.

### DETAILED DESCRIPTION

The following detailed description refers to the accompanying drawing that show, by way of illustration, specific details and embodiments in which the disclosure may be practiced.

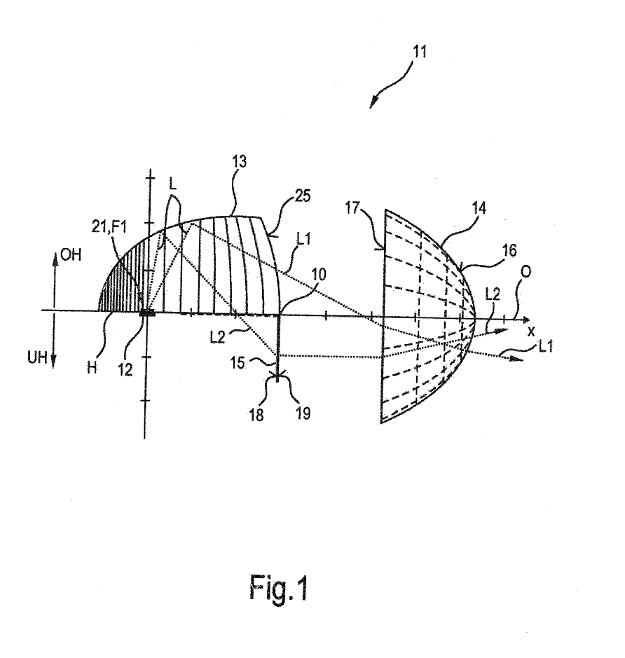

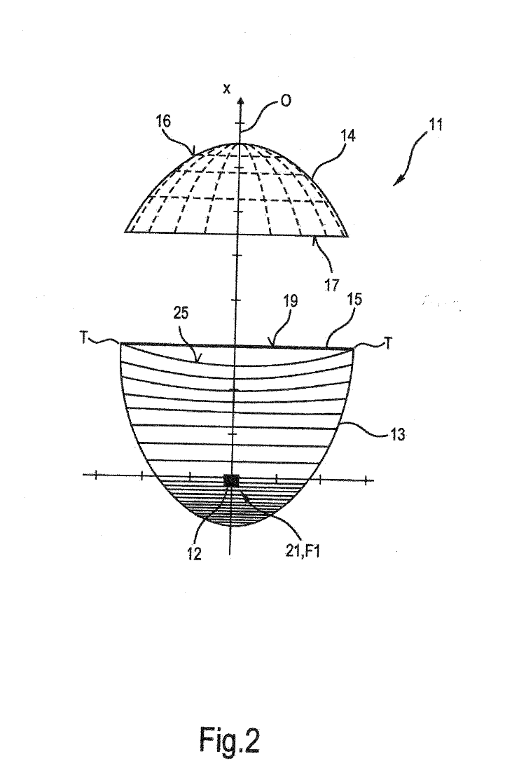

FIG. 1 shows a vehicle lighting device 11 as a sectional illustration in side view, which vehicle lighting device is suitable in particular for use as a headlight of a motor vehicle. FIG. 2 shows the vehicle lighting device 11 in a plan view.

The vehicle lighting device 11 includes at least one light generating unit 12, an approximately ellipsoidal reflector 13, a lens 14 and an aperture 15. These elements may be accommodated in a dust- and/or moisture-tight housing arrangement (not illustrated).

The reflector 13 is designed here purely by way of example as a half-shell reflector having an approximately ellipsoidal reflection surface. The reflector 13 has a main body composed of plastic with a specularly reflective reflection surface at its inner side. A front edge 25 of the reflector 13 is curved laterally toward the front and ends at points T, as shown in FIG. 2. A lower edge of the reflector 13 lies on a plane which also represents a horizontal principal plane H of the reflector 13. The optical axis O of the lens 14 lies in the principal plane H, and the principal plane H divides the illustrated space imaginarily into an upper half-space OH and a lower half-space UH. While half of the lens 14 is situated in the upper half-space OH and the other half is situated in the lower half-space UH, the reflector 13 is situated in the upper half-space OH and the aperture 15 is situated in the lower half-space UH.

The reflector 13 has an internal focal point F1 overarched by the reflector 13 and an external focal point lying between the internal focal point F1 and the lens 14. The second focal point may correspond, in particular, to a focal point of the lens 14. A light exit surface (not illustrated) of the light generating unit 12 is situated in the region of the internal focal point F1. The focal points, e.g. F1, may also be regarded as focal spots on account of the light exit surface not being negligibly small. The light generating unit 12 here includes conversion light emitting diodes 21, which emit white light or blue-yellow mixed light. By way of example, a diffuser may be disposed downstream of the conversion light emitting diodes 21. When the light emitting diodes 21 are activated or the light generating unit 12 is activated, light L emerging at the light exit surfaces of the light emitting diodes 21 is radiated into the reflector 13. The reflector 13 is therefore disposed optically downstream of the light generating unit 12.

The lens 14 disposed optically downstream of the reflector 13 has an aspherical shape and is embodied as rotationally symmetrical about its optical axis O. The optical axis O is depicted here as lying horizontally. The lens 14 thus has a planoconvex basic shape, wherein a convex, front surface 16 has an aspherical shape and a planar, rear surface 17 is perpendicular to the optical axis O, which here coincides with the x-axis. The lens 14 consists of PMMA. A diameter of the lens 14 perpendicular to the optical axis O (which corresponds to a circle diameter of the planar rear surface 17) here is approximately 50 mm given a thickness along the optical axis O of approximately 20 mm. A length of the vehicle lighting device 11 is, in particular, between 80 mm and 90 mm.

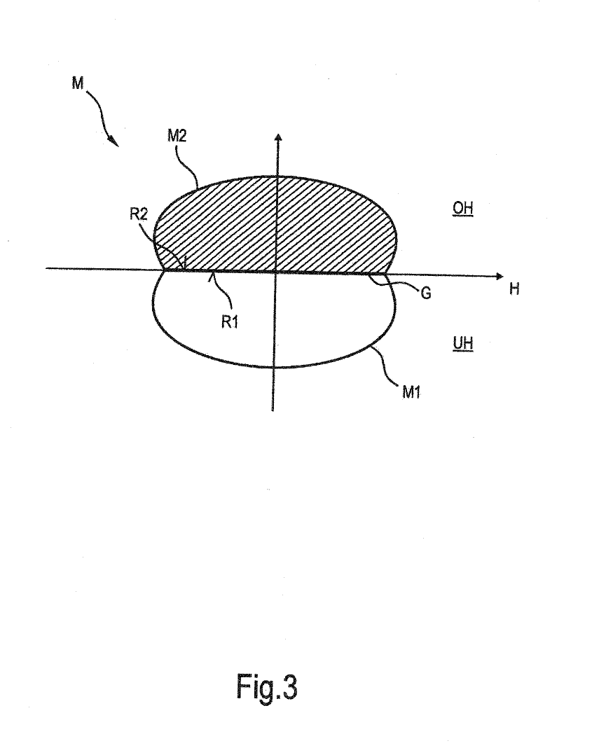

The aperture 15 is designed here as a perpendicular plate having a rear side 18 oriented rearward and a front side 19 oriented frontward. The aperture 15 is partly interposed into a beam path between the reflector 13 and the lens 14. An upper edge, the cut-off edge 10, of the aperture 15 touches the optical axis O. The second (external) focal point or focal spot of the reflector 13 may be situated at the point of intersection between the optical axis O and the cut-off edge 10. The aperture 15, by means of the cut-off edge 10, generates a bright-dark boundary G in the image or light emission pattern M1 projected by the lens 14 (see FIG. 3), which is generated by means of the light L1 radiated onto the lens 14 directly by the reflector 13. The bright-dark boundary G may be prescribed for example for operation of a vehicle in road traffic. To put it more precisely, the light emission pattern M1 projected behind the lens 14 (i.e. in the direction of the x-axis) has in the far field a bright-dark boundary G at its upper edge, while the light emission pattern has a lower bright-dark boundary at the output of the reflector 13.

The aperture 15, which is therefore optically interposed between the reflector 13 and the lens 14, is furthermore designed and arranged to block one part of a light L2 reflected by the reflector 13 onto the aperture 15 and to direct another part L2t of the light L2 reflected by the reflector 13 onto the aperture 15 onto the lens 14, as will be explained in greater detail below.

In another variant, the aperture 15 (depicted by dashes in that case) lies horizontally on the principal plane H of the reflector 3 and thus at least partly represents the base thereof. However, the aperture 15 may also be slanted, etc.

FIG. 3 shows a frontal view of a light emission pattern M generated in the far field along the optical axis O behind the lens 14 by the vehicle lighting device 11. A lower region M1 of the light emission pattern M situated below the principal plane H has a sharp bright-dark boundary G at its upper edge R1 and is generated by the light L1 that passes directly from the reflector 13 into the lens 14. An upper region M2 of the light emission pattern M situated above the principal plane H adjoins the bright-dark boundary G at its lower edge R2 and is generated by light L2t that passes from the reflector 13 firstly onto the aperture 15 and from there partly into the lens 14. A relative brightness of the regions M1 and M2 may be set by a light transmitting capability of the aperture 15, for example, and the shape of the upper region M2 may be set e.g. by the shape of the aperture 15. The upper region M2 of the light emission pattern M typically has a lower brightness than the lower region M1.

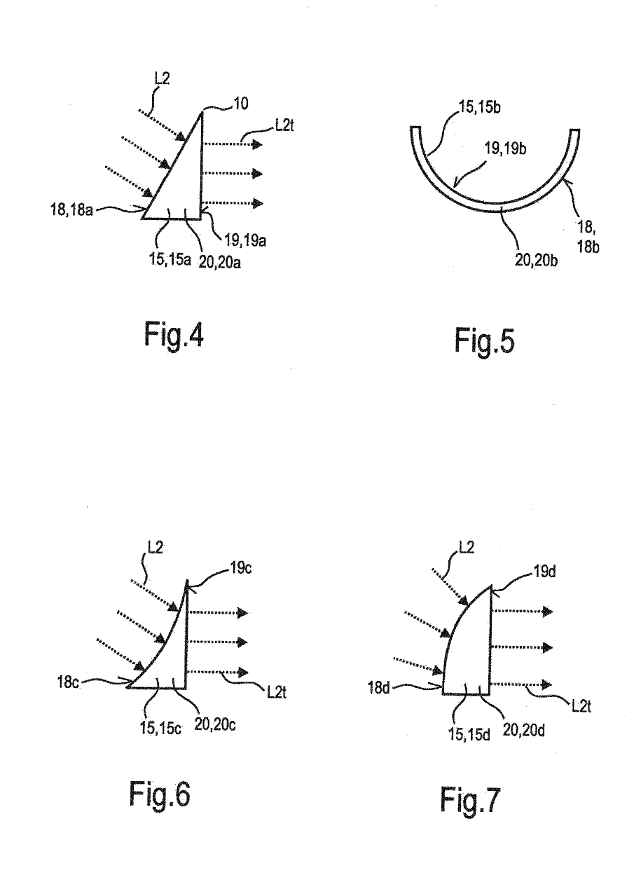

FIG. 4 shows one possible configuration of the aperture 15 in the form of a partly transmissive aperture 15a as a sectional illustration in side view. A rear side 18a of the aperture 15a may be irradiated with light L2 (directly) by the reflector 13. The aperture 15a is partly transmissive to the effect that it absorbs one part of the light L2 incident at its rear side 18a and transmits another part L2t through its light-transmissive main body 20, 20a and thus emits it at its front side 19a in the direction of the lens 14. This light L2t emitted at the front side 19a and passing through the lens 14 may be incident in the far field in particular into a spatial region outside the light emission pattern M1, e.g. may generate the upper region M2 of the light emission pattern M. The light L2t emitted at the front side 19a of the aperture 15a may partly also go past the lens 14 and then be used in particular for effect lighting or be absorbed.

A partial transmissivity of the aperture 15a may be achieved for example by a corresponding covering (layer, layer stack, etc.) of the main body 20, 20a, in particular of the rear side 18a.

The light-transmissive main body 20 may generally be a transparent or a translucent (diffusely scattering) main body. Very generally, the main body 20 may serve as an optical element, e.g. for beam shaping and/or beam guiding or beam deflection. For this purpose, the main body 20, 20a here has a triangular shape for example in cross section.

The main body 20 may generally be embodied in particular as a profile body in the sense that it is continued perpendicularly to the image plane (perpendicularly to the longitudinal axis in the principal plane H).

FIG. 5 shows a plan view of a further possible configuration of the aperture 15 in the form of a partly transmissive aperture 15b having a corresponding rear side 18b and front side 19b. The aperture 15b here is not embodied as a linear profile body, but rather has a front side 19b curved in a transverse direction, e.g. for diverse light directing of the light L2t and configuration of the light emission pattern M2.

FIG. 6 shows, as a sectional illustration in side view, yet another possible configuration of the aperture 15 in the form of a partly transmissive aperture 15c similar to the aperture 15a. However, here for the purpose of altered beam guiding in the main body 20, 20c, the rear side 18c of the aperture 20c is embodied as concave, while the front side 19c is embodied as planar. However, alternatively, the front side 19c may also have a non-planar, e.g. convex or concave, basic shape.

FIG. 7 shows, as a sectional illustration in side view, yet another possible configuration of the aperture 15 in the form of a partly transmissive aperture 15d similar to the aperture 15a. However, here for altered beam guiding in the main body 20, 20d, the rear side 18d is embodied as curved rearward, e.g. concavely, while the front side 19d is embodied as planar. However, alternatively, here as well, the front side 19d may have a non-planar, e.g. convex or concave, basic shape.

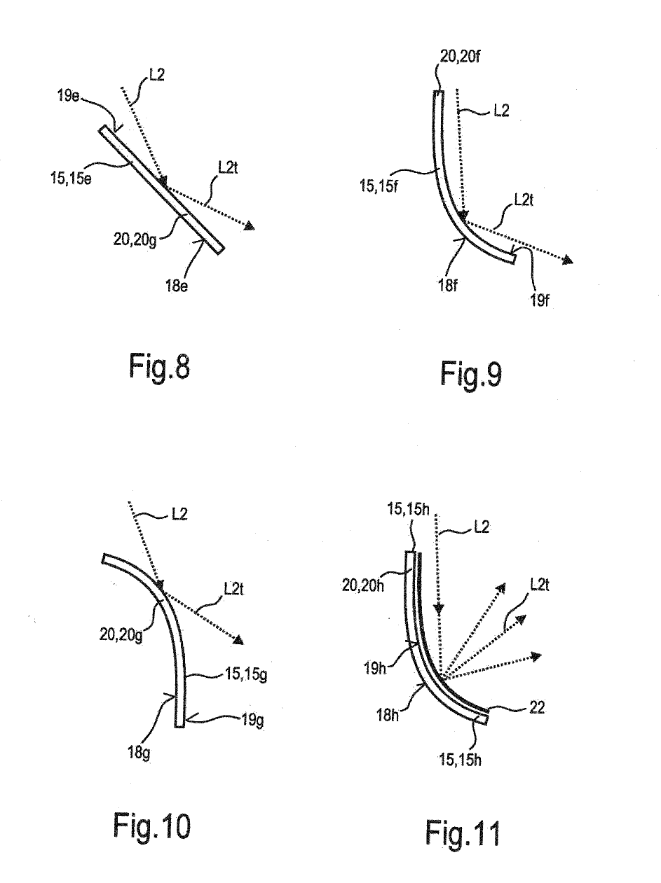

FIG. 8 shows, as a sectional illustration in side view, yet another possible configuration of the aperture 15 in the form of an aperture 15e having a light-absorbing rear side 18e and a diffusely or specularly reflective front side 19e. The aperture 15e is arranged such that one part of the light L2 incident on it from the reflector 13 impinges on the rear side 18e and another part L2t of the light L2 incident on it from the reflector 13 is incident on the front side 19e. The light L2t incident on the front side 19e is reflected, in particular diffusely, into the lens 14, e.g. in order to form the light emission pattern M2. The aperture 15e here has in particular a planar front side 19e.

FIG. 9 shows, as a sectional illustration in side view, yet another possible configuration of the aperture 15 in the form of an aperture 15f, which differs from the aperture 15e by virtue of its concave reflective front side 19f. Greater light concentration may be achieved as a result.

FIG. 10 shows, as a sectional illustration in side view, yet another possible configuration of the aperture 15 in the form of an aperture 15g, which differs from the aperture 15e by virtue of its convex reflective front side 19g. Greater beam expansion may be achieved as a result.

FIG. 11 shows, as a sectional illustration in side view, a variant of the aperture 15f, namely an aperture 15h, the front side 19g of which is covered with a phosphor layer 22. The phosphor layer 22 includes one or a plurality of wavelength-converting phosphors capable of converting the light L2 incident from the reflector 13 at least partly into light having a longer wavelength. A differentiation or adaptation of the light emission pattern M2 from or to the light emission pattern M1, including in terms of color, may be carried out as a result. The light L2t emitted by the phosphor layer 22 is typically emitted non-directionally or diffusely.

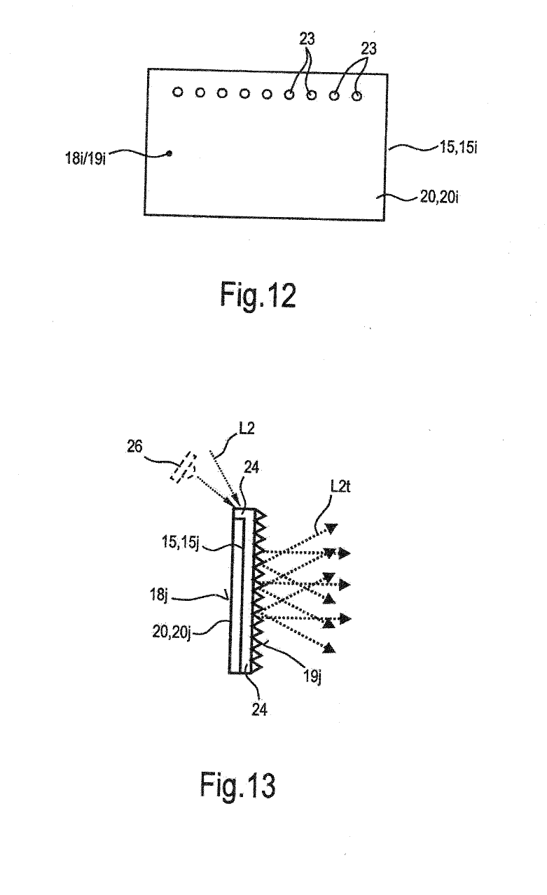

FIG. 12 shows a frontal view of yet another possible configuration of the aperture 15 in the form of an aperture 15i, which has a plurality of light transmitting openings 23 running from the rear side 18h to the front side 19h in an otherwise light-nontransmissive main body 20h. The aperture 15i may be irradiated in particular only on the rear side, and the light emission pattern M2 may be generated by means of light L2t transmitted through the light transmitting openings 23.

FIG. 13 shows, as a sectional illustration in side view, another aperture 15, namely an aperture 15j with an optical waveguide 24 arranged at the top side and at the front side 19j. The rear side 18j is designed to be light-nontransmissive. In the case of this aperture 15j, light L2t incident at the top side from the reflector 13 may be guided by means of the optical waveguide 24 to the front side 19j, where it is coupled out at least partly in the direction of the lens 14.

Additionally or alternatively, the optical waveguide 24 may be irradiated by an additional, in particular dedicated, light source, e.g. by at least one light emitting diode 26 or other semiconductor light source (depicted by dashes).

Although the disclosure has been more specifically illustrated and described in detail by the exemplary embodiment shown, nevertheless the disclosure is not restricted thereto and other variations may be derived therefrom by the person skilled in the art, without departing from the scope of protection of the disclosure.

In this regard, the convex surface of the lens may also be an ellipsoidal or paraboloidal surface. Generally, the lens is not restricted to convex lenses, but rather may e.g. also include concave or convexoconcave lenses. A lens may generally be understood to mean an optical imaging element or imaging system, which may also include a lens in the narrower sense.

Generally, the position and rotational position of the elements of the vehicle lighting device with respect to one another may vary. In this regard, the light generating unit or the light exit surface thereof may be angled relative to the principal plane of the reflector or be displaced from the internal focal point. Moreover, the aperture may be rotated and/or displaced relative to the lens.

Moreover, the reflector may be angled relative to the lens. In particular, the principal plane H of the reflector may be slanted with respect to the optical axis of the lens. An associated inclination angle α is preferably not more than approximately 20°. As a result, color segregations may be at least partly compensated for, and monochromatic color fringes are reduced.

The aperture may furthermore optionally be removable from the beam path and reintroducible, e.g. tiltable or pivotable, in order to be able to illuminate a larger region, e.g. during off-road use of the electric bicycle.

The aperture may have further forms other than the forms shown. In particular, features of the apertures may be used alternatively or additionally. By way of example, all the apertures shown may be provided with phosphor and/or have a non-planar shape in plan view.

1. A lighting device, comprising:
a reflector, which is illuminated by means of at least one light source,
a lens disposed downstream of the reflector, and
an aperture interposed between the reflector and the lens,
wherein the aperture is designed and arranged
to block one part of a light reflected by the reflector onto the aperture and
to direct another part of the light reflected by the reflector onto the aperture onto the lens.

2. The lighting device as claimed in claim 1, wherein the aperture is a partly transmissive aperture.

3. The lighting device as claimed in claim 2, wherein the aperture has a partly transmissive coating.

4. The lighting device as claimed in claim 2, wherein the aperture has at least one light transmitting opening and is otherwise light-nontransmissive.

5. The lighting device as claimed in claim 2, wherein the aperture has a beam-shaping main body.

6. The lighting device as claimed in claim 1, wherein the aperture is designed and arranged such that light incident on its rear side from the reflector is at least partly blocked and its front side is embodied in a reflective fashion at least in regions.

7. The lighting device as claimed in claim 1, wherein the aperture has at the top side and at its front side an optical waveguide that is irradiated by the reflector and the optical waveguide is designed to couple out light at the front side.

8. The lighting device as claimed in claim 7, wherein the optical waveguide is irradiated by means of an additional light source.

9. The lighting device as claimed in claim 1, wherein the aperture is covered with at least one phosphor.

10. The lighting device as claimed in claim 1, wherein the reflector is embodied as a half-shell reflector, and the aperture has a cut-off edge on a principal plane of the reflector.

11. The lighting device as claimed in claim 1, wherein the lighting device is a vehicle lighting device.

12. The lighting device as claimed in claim 11, wherein the vehicle lighting device is a lighting device for an electric bicycle.

13. The lighting device as claimed in claim 1, wherein the lighting device is a headlight.
